(19) United States
(12) Patent Application Publication
(10) Pub. No.: US 2026/0269493 A1
(43) Pub. Date: Sep. 10, 2026

(54) SURFACE MOUNT ELECTRICAL CONNECTOR

(71) Applicant: Lumileds LLC, San Jose, CA (US)

(72) Inventor: Luca Mucchetti, Aachen (DE)

(73) Assignee: Lumileds LLC, San Jose, CA (US)

(21) Appl. No.: 18/880,206

(22) PCT Filed: Jun. 30, 2023
(86) PCT No.: PCT/US2023/026677

§ 371 Date: Dec. 30, 2024

Related U.S. Application Data
(60) Provisional application No. 63/357,460, filed on Jun. 30, 2022.

(51) Int. Cl. H01R 12/51; H01R 4/18; H01R 12/52; H01R 12/53

(52) U.S. Cl. CPC H01R 12/515; H01R 4/184; H01R 12/52; H01R 12/53

(57) ABSTRACT

A surface mount electrical connector comprises a housing comprising at least first and second elongate housing portions. Each elongate housing portion extends longitudinally from a first end of the housing to an opposing second end of the housing. The first elongate housing portion comprises an opening at the first end of the housing and a wall portion at the second end of the housing. The second elongate housing portion comprises an opening at the opposing second end of the housing, and a wall portion at the first end of the housing.

### CROSS-REFERENCE TO RELATED APPLICATIONS

This application claims the benefit of U.S. Provisional Application No. 63/357,460, filed Jun. 30, 2022, the contents of which are incorporated herein by reference.

### BACKGROUND

In wire to board applications, printed circuit boards (PCBs) may be interconnected in series or cascade by wires extending from one PCB to the next. Interconnection wires can extend to and from each PCB in different directions and from opposite sides of each PCB. However, conventional Surface Mount Device (SMD) connectors have wire entries on one side only. Connecting circuit boards in series or cascade using conventional connectors involves bending the wires to route the wires around the connectors to extend from one PCB to the next, or else using two separate connectors on each PCB, one for wire entry and one for wire exit.

### SUMMARY

A surface mount electrical connector includes a housing that includes at least first and second elongate housing portions. Each elongate housing portion extends longitudinally from a first end of the housing to an opposing second end of the housing. The first elongate housing portion includes an opening at the first end of the housing and a wall portion at the second end of the housing. The second elongate housing portion includes an opening at the opposing second end of the housing, and a wall portion at the first end of the housing.

### BRIEF DESCRIPTION OF THE DRAWINGS

A more detailed understanding can be had from the following description, given by way of example in conjunction with the accompanying drawings wherein:

FIG. 1 is a perspective view of an example electrical connector;

FIG. 2 depicts conductive contacts within a housing of the example electrical connector of FIG. 1;

FIG. 3A is a perspective view of another example electrical connector;

FIG. 3B depicts conductive contacts within a housing of the example electrical connector shown in FIG. 3A;

FIG. 4 is perspective view showing relative dimensions of the example electrical connector of FIGS. 3A and 3B;

FIG. 5 depicts an example conductive contact suitable for any of the examples described herein;

FIG. 6 is a top view of an example arrangement of electrical connectors corresponding to the example of FIGS. 1 and 2, mounted on printed circuit boards;

FIG. 7 is a top view of an example arrangement of electrical connectors corresponding to the example of FIGS. 1 and 2, mounted on printed circuit boards;

FIG. 8 is a top view of electrical connectors of the type shown in FIGS. 3A and 3B mounted on printed circuit boards; and

FIG. 9 is a top view of electrical connectors according to another example, mounted on printed circuit boards.

### DETAILED DESCRIPTION

Examples of different light illumination systems and/or light emitting diode (“LED”) assemblies, components and implementations will be described more fully hereinafter with reference to the accompanying drawings. These examples are not mutually exclusive, and features found in one example may be combined with features found in one or more other examples to achieve additional implementations. Accordingly, it will be understood that the examples shown in the accompanying drawings are provided for illustrative purposes only and they are not intended to limit the disclosure in any way. Like numbers refer to like elements throughout.

It will be understood that, although the terms first, second, third, etc. may be used herein to describe various elements, these elements should not be limited by these terms. These terms may be used to distinguish one element from another. For example, a first element may be termed a second element and a second element may be termed a first element without departing from the scope of the present invention. As used herein, the term “and/or” may include any and all combinations of one or more of the associated listed items.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there may be no intervening elements present. It will also be understood that when an element is referred to as being “connected” or “coupled” to another element, it may be directly connected or coupled to the other element and/or connected or coupled to the other element via one or more intervening elements. In contrast, when an element is referred to as being “directly connected” or “directly coupled” to another element, there are no intervening elements present between the element and the other element. It will be understood that these terms are intended to encompass different orientations of the element in addition to any orientation depicted in the figures.

Relative terms such as “below,” “above,” “upper,”, “lower,” “horizontal” or “vertical” may be used herein to describe a relationship of one element, layer, or region to another element, layer, or region as illustrated in the figures. It will be understood that these terms are intended to encompass different orientations of the device in addition to the orientation depicted in the figures.

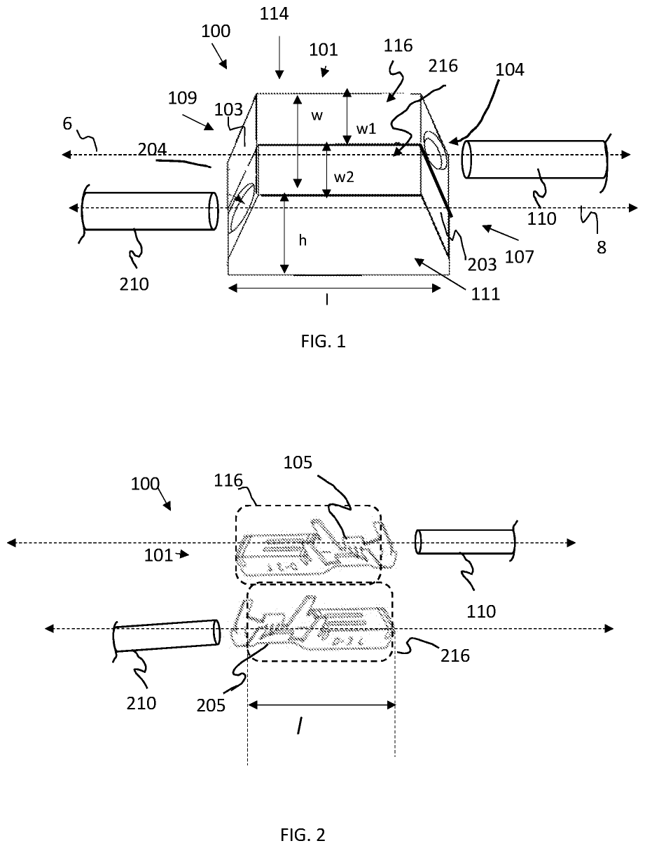

FIG. 1 is a perspective view of an example connector 100. Connector 100 may be implemented as a PCB terminal block. A PCB terminal block is typically used to supply power to or from a PCB and may terminate a wire at the PCB. A conventional PCB terminal block has at least two slots available to insert wires. However, the slots are typically provided only on one side of the terminal block for conventional blocks. In other words, each wire entering (or exiting) the terminal block has its entry (or exit) slot on the same side of the connector as each of the other wires.

Electrical devices are often attached to printed circuit boards (PCBs) by soldering terminals of the electrical device to a surface of the PCB. Surface Mount Technology (SMT) is a particular method of soldering electrical terminals to a PCB. SMT has been developed to affix electrical devices upon PCBs in an automated manner, but the devices may also be placed manually. SMT has reduced cost and improved reliability, and reduces the overall physical size of the PCB in many applications. SMT allows for mounting electrical devices on both sides of a PCB, which was not possible using through hole mounting technology. The components are typically mounted on the board by an automated method such as a robot assisted assembly line. Electrical points of contact between the components and the board may be treated with solder paste. Assembled PCBs may then be treated in a high temperature oven at temperatures of up to about 265° C. or higher to reflow the solder. The oven may be operated with an air atmosphere or under an inert atmosphere such as nitrogen.

Electronic devices so made are called surface-mount devices (SMDs). SMT has largely replaced the previous construction method of fitting components with wire leads into holes in the circuit board, which is called through-hole technology. An SMT component is usually smaller than its leaded counterpart because it has no leads or smaller leads. It may have short pins or leads of various styles, flat contacts, a matrix of balls, or other terminations on the body of the component to assist with fixing the component to the board and/or establish an electrical connection between the board and the component.

PCBs supporting light emitting diodes (LEDs) may be used to form light displays. Often, multiple LED lighting PCBs are coupled in series by interconnecting wires to form a string of PCBs. The string of PCBs provides for a flexible light source able to adapt to the contours of large letters used in signage. Current practice is to connect the wires to the PCBs by soldering the leads of the wires to the top surface of the PCB. The step of soldering the wire leads to the boards is time consuming and costly.

A conventional connector for attaching a wire lead to a PCB receives a wire lead to be connected on one side of the connector. This connector may receive more than one wire lead, but the wire leads enter the connector from the same side. When using this connector to string PCBs in series, one connector receives and secures wires from an electrical device from a first direction, and another connector receives and secures wires from another electrical device from the opposite direction. Therefore, at least two separate connectors would be necessary to provide an electrical connection in a series string of PCBs. Otherwise, it would be necessary to bend the wires to route the wires around the connectors to extend from one PCB to the next.

Therefore, there is an unmet need to provide a single connector for securely connecting a first wire lead to an electrical device from a first direction and a second wire lead from a second electrical device from an opposite direction by a simple, reliable and cost effective process, such as an SMT automated process. It may be desirable for the connector to approach the small physical size envelope of the wires to be soldered to the PCB so as not to shadow any neighboring components.

Embodiments described herein provide for a low profile feed-through surface mounted electrical connector (SMEC) for connecting at least two wire leads to a printed circuit board (PCB) or another suitable component surface. The low profile of the connector reduces shadowing by the connector when mounted on a PCB supporting LEDs. The SMEC may be attached to the PCB by surface mount technology (SMT), a standardized automated process for placing and attaching electrical and electronic components to PCBs. Attachment may be by soldering, using a conductive adhesive, or other similar method.

The connector may be formed of a housing and a plurality of conductive contacts. The housing may include a first side having an opening for a first wire end to be inserted and securely connected to a first conductive contact. The housing may have a second side opposite the first side. The second side may have an opening for a second wire end to be inserted and securely connected to a second conductive contact. The connector may be attached to the PCB by conventional SMT techniques. The conductive contact can include an attachment point for attaching the electrical connector to a printed circuit board and can provide an electrical connection between the first wire and the second wire. The conductive contact can further include a wire engaging mechanism for securing the first wire to the conductive contact. For example, in some instances the wire engaging mechanism can comprise a lance formed into the conductive contact.

The surface mount connector may be particularly applicable for printed circuit boards supporting LEDs. Referring to FIGS. 1 and 2, there is shown an exemplary embodiment of a surface mount connector 100. In the example illustrated in FIGS. 1 and 2, connector 100 includes a generally rectangular housing 101 having opposing first and second generally rectangular side walls 111 and 112 (not visible in FIGS. 1 and 2) each side wall having a height h and a length l; opposing generally rectangular first and second end walls 107, 109, each end wall having a width w and a height substantially the same as the height of the side walls; and generally rectangular opposing top 114 and bottom 124 (not visible in FIGS. 1 and 2) planar portions, each planar portion having one dimension corresponding to a length of a side wall 111 or 112, and another dimension corresponding to a width of an end wall 107 or 109.

In some instances, top planar portion 114 can have a length l and width w that defines an area smaller than the area defined by a length l and width w of opposing bottom planar portion 114. In those instances, opposing first and second end walls 107, 109 may not extend orthogonally from edges of top planar portion 114 to corresponding edges of bottom planar portion 124. In some instances, housing 101 can have a generally rounded shape.

Housing 101 comprises at least first 116 and second 216 elongate housing portions, formed as integral structural parts of housing 101. Each elongate housing portion 116, 216 may be defined by a length l and a width w and extends longitudinally, i.e., lengthwise from a first end 107 of housing 101 to an opposing second end 109 of housing 101. First elongate housing portion 116 may be arranged with respect to second elongate housing portion 216 so that a longitudinal axis, e.g., axis 6, of first elongate housing portion 116 runs parallel to a longitudinal axis, e.g., axis 8 of second elongate housing portion 216.

First elongate housing portion 116 is shown to define an opening 104 at the first end 107 of housing 101 to receive a first wire 110, and a wall portion 103 at opposing second end 109 of housing 101. Wall portion 103 is configured to prevent the first wire 110 inserted in opening 104 at first end 107 of housing 101, from extending past opposing second end 109 of housing 101. In other words, each elongate housing portion has only to receive a wire at one of its ends. The opposing end of each elongate housing portion is closed so that a wire cannot be inserted into housing 101, nor can a wire extend from housing 101 at the closed end. Accordingly, second elongate housing portion 216 is shown to define an opening 204 to receive a wire 210 at second end 109 of housing 101, and a wall portion 203 at first end 107 of housing 101.

As described above and illustrated in FIGS. 1 and 2, housing structures comprising connectors 100 within the scope of the disclosure are defined by a plurality of elongate housing portions such as portions 116, 216 as specified above, each having only one wire entry/exit opening, and arranged so as to provide housing 101 with at least one wire entry/exit opening at each end 107, 109 of housing 101.

Electrical connector 100 further includes a first conductive contact 105 disposed within the first elongate housing portion 116. Conductive contact 105 is configured to electrically connect to first wire 110 received through opening 104 in first end 107 of housing 101. Electrical connector 100 further includes at least one second conductive contact disposed within second elongate housing portion 216, and arranged to electrically connect to second wire 210, when wire 210 is received through opening 204 in second end 109 of housing 101.

Housing 101 can include any number of elongate housing portions such as portion 116. However, each elongate housing portion provides only one opening and includes only one corresponding conductive contact. Accordingly, one dimension of planar bottom portion 124 of housing 101, e.g., a width, can be as small as the length of a single conductive contact. In other words, the length of each elongate housing portion need be no longer than is sufficient to allow one corresponding conductive contact to be disposed therein, and need not be extended lengthwise to accommodate a second conductive contact in the same elongate housing portion.

Each conductive contact 105, 205 can include an engaging mechanism (not shown) for securing leads of a corresponding wire to the conductive contact. Each conductive contact can further include attachment points for connecting the conductive contact to a corresponding non-conductive structural portion of housing 101. Each conductive contact can further include attachment points for connecting an elongate housing structure to a substrate, e.g., a surface of a printed circuit board (PCB), e.g., by soldering to corresponding conductive contacts on the surface of the PCB.

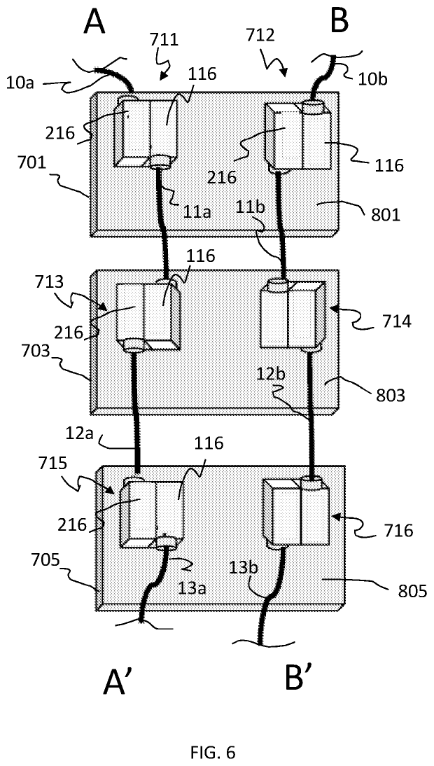

In some instances (see, e.g., FIG. 6), the first conductive contact 105 is electrically connected to the second conductive contact 205 so that when the first conductive contact is connected to the first wire and the second conductive contact is connected to the second wire, the first wire will be electrically connected to the second wire. For example, the first electrical contact can be electrically connected to the second electrical contact by a conductive portion disposed within housing 101.

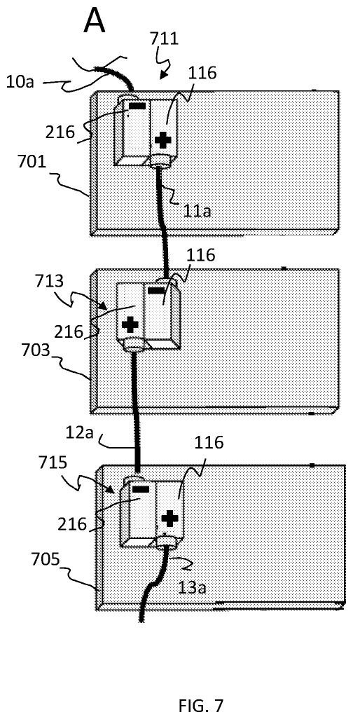

In another example, the first conductive contact is configured so that a conductive portion 151 extends through bottom planar portion 124 of housing 101 and the second conductive contact is likewise configured so that a conductive portion 251 extends through bottom planar portion 124 of housing 101. In that example, the first conductive contact can be electrically connected to the second conductive contact by a conductive portion disposed on a surface of the printed circuit board and arranged to extend between conductive portion 151 and conductive portion 252 so as to electrically connect conductive contact 105 to conductive contact 205. In another example (see, e.g., FIG. 7), first conductive contact 105 is electrically isolated from second conductive contact 205.

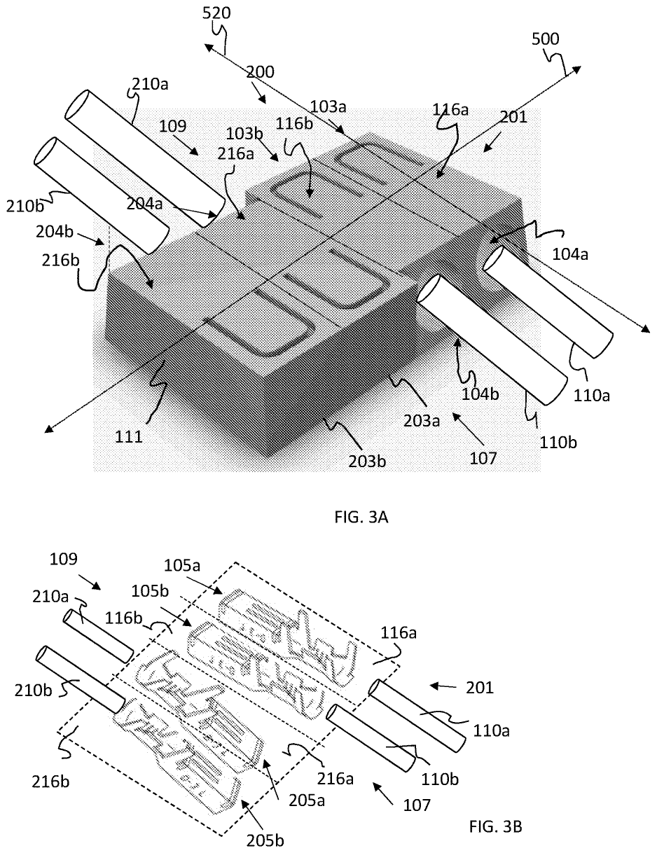

FIG. 3A is a perspective view of another example connector 200 according to the disclosure. Like connector 100 shown in FIGS. 1 and 2, connector 200 comprises a generally rectangular housing 201 defined by a plurality of elongate housing portions. Housing 201 of connector 200 is defined by four elongate housing portions 116a, 116b, 216a and 216b. Like the elongate housing portions described above with respect to FIGS. 1 and 2, each of the elongate portions 116a, 116b, 216a and 216b defining housing 201 of FIG. 3A has one end providing a corresponding opening at either end wall 107 or opposing end wall 109.

Each elongate housing portion 116a, 116b, 216a and 216b is defined by a length I and a width w and each extends longitudinally, i.e., lengthwise from a first end 107 of housing 201 to an opposing second end 109 of housing 201. First elongate housing portion 116a is arranged with respect to second elongate housing portion 116b so that a longitudinal axis, e.g., axis 6, of first elongate housing portion 116a runs parallel to longitudinal axes of second elongate housing portion 116b, third elongate housing portion 216a and fourth elongate housing portion 216b.

First elongate housing portion 116a is shown to define an opening 104a at the first end 107 of housing 101 to receive a first wire 110a, and a wall portion 103a at opposing second end 109 of housing 101. Wall portion 103a is configured to prevent the first wire 110a inserted in opening 104a at first end 107 of housing 201, from extending past opposing second end 109 of housing 201. Second elongate housing portion 116b is shown to define an opening 104b at first end 107 of housing 201 to receive a second wire 110b, and a wall portion 103b at opposing second end 109 of housing 201. Wall portion 103b is configured to prevent second wire 110b inserted in opening 104b at first end 107 of housing 201, from extending past opposing second end 109 of housing 201. In other words, each elongate housing portion has an opening to receive a wire at only one of its ends. The opposing end of each elongate housing portion is closed so that a wire cannot be inserted into housing 201, nor can a wire extend from housing 201 at the closed end of an elongate housing portion.

Third elongate housing portion 216a defines an opening 204a (not visible in FIG. 3A at end 109 of housing 201 to receive a third wire 210a, and a wall portion 203a at opposing end 109 of housing 201. Wall portion 203a is configured to prevent the third wire 210a inserted in opening 204a at end 109 of housing 201, from extending past opposing second end 107 of housing 201. Fourth elongate housing portion 216b defines an opening 204b (not visible in FIG. 3) at end 109 of housing 201 to receive a fourth wire 210b, and a wall portion 203b at opposing end 109 of housing 201. Wall portion 203b is configured to prevent fourth wire 210b inserted in opening 204b (not visible in FIG. 3) at end 109 of housing 201, from extending past opposing second end 107 of housing 201.

In the arrangement shown in FIG. 3A, housing 201 provides two adjacent wire entries/exits on a first side of housing 201 and two adjacent wire entries/exists on the side opposite the first side of housing 201. Of course, the arrangement shown in FIG. 3 can be extended in either or both directions along longitudinal axis 500 by adding any number of elongate housing portions arranged so that their longitudinal axes, e.g., axis 530, are in parallel. FIG. 3B shows conductive contacts 105a, 105b, 205a and 205b disposed within housing 201 of electrical connector 200 as illustrated in FIG. 3A.

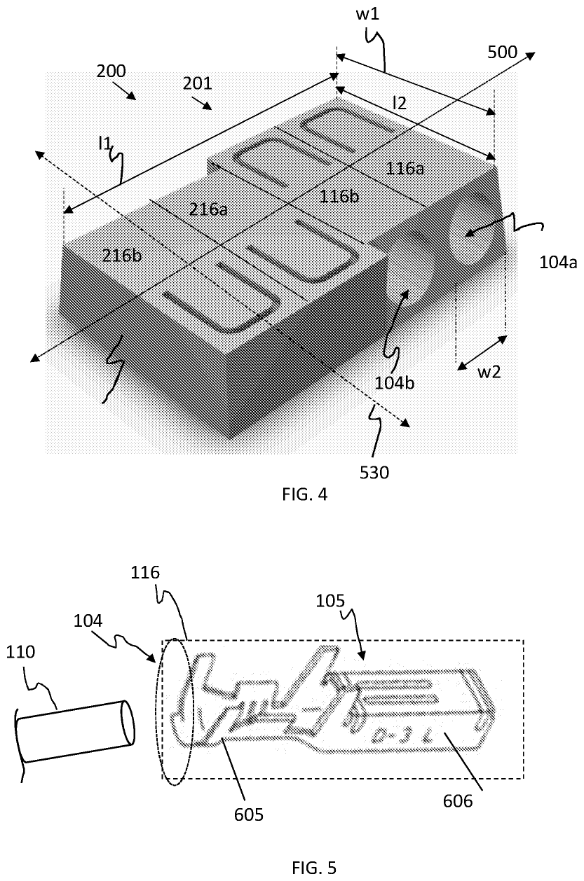

FIG. 4 shows relative dimensions of housing 201 of connector 200 illustrated in FIGS. 3A and 3B. Housing 201 extends lengthwise along longitudinal axis 500 and widthwise along lateral axis 420. Lateral axis 520 of housing 201 extends parallel to a longitudinal axis 520 of each elongate housing portion 116a, 116b, 216a and 216b. Each elongate housing portion has a width dimension w2 and a length dimension 12 (one shown for portion 116a). Length dimension 12 of an elongate housing portion defines a width dimension w1 of housing 201. Length dimension 11 of housing 201 is approximately the width dimension w2 of an elongate housing portion multiplied by a number of elongate housing portions defining housing 201. Four elongate housing portions are shown in the example of FIG. 4

FIG. 5 shows an example conductive contact 105 disposed within an elongate housing portion 116. Conductive contact 105 includes an end portion 605 structured to receive an end of wire 110 via opening 104, and an opposing end portion 606 structured to secure wire 110 to conductive contact 105 and to prevent wire 110 from extending from conductive contact 105 past end portion 605.

FIG. 6 shows three printed circuit boards (PCBs) 701, 703 and 705, each respective PCB defined by a corresponding, respective top planar surface 801, 803, 805. First and second electrical connectors 711 and 712 are mounted on top planar surface 801 of PCB 701. First and second electrical connectors 713 and 714 are mounted on top planar surface 803 of PCB 703. First and second electrical connectors 715 and 716 are mounted on top planar surface 805 of PCB 705.

Each electrical connector on each PCB corresponds to electrical connector 100 as illustrated in FIGS. 1 and 2 and as described above with respect to FIGS. 1 and 2. Accordingly, each electrical connector includes a housing 101 defined by at least a first elongate housing portion 116 and a second elongate housing portion 216. In the example of FIG. 6, first and second conductive contacts 105, 205 (best shown in FIG. 2) of each electrical connector are electrically connected to each other so that, for example, wire 10a entering a first side of PCB 701 is electrically connected to wire 11a exiting PCB 701 at a side opposite the first side of PCB 701. In this configuration, a first string A of electrical connectors 100 can for example provide a power supply path that distributes power to each successive PCB 701, 703, 705, and a second string B of electrical connectors can provide a return path to each successive PCB 701, 703, 705. In other examples string A could allow distribution of a first control or data signal to each successive PCB. 701, 703, 705, and string B could distribute a second control or data signal to each successive PCB 701, 703.

Regardless of configuration or arrangement on one or more PCBs, the connector 100 allows first wire 10a entering the first side of PCB 701 to be electrically connected to wire 13a exiting PCB 705 at a side of PCB 705 opposite the first side of PCB 701 without the need to wind intermediate wires 11a and 12a around electrical connectors on each PCB in order to connect wires 11a and 13a to the next successive electrical connector on the next successive PCB. At the same time, each housing of each electrical connector 711, 713 and 715 has a footprint on a corresponding surface of a corresponding PCB that extends substantially no farther in one dimension than a length of one conductive contact.

FIG. 7 shows a series arrangement in which each electrical connector 711, 713, 715, 712, 714 and 716 corresponds to electrical connector 100 illustrated in FIG. 1. In the arrangement of FIG. 7, conductive contact 105 (best illustrated in FIG. 2) disposed within elongate housing portion 116 of electrical connector 100 is electrically isolated from conductive contact 205 within elongate housing portion 216 of electrical connector 100. Accordingly, in the example of FIG. 7, wire 10a is electrically isolated from wire 11a, and wire 11a is electrically isolated from wire 12a and so forth.

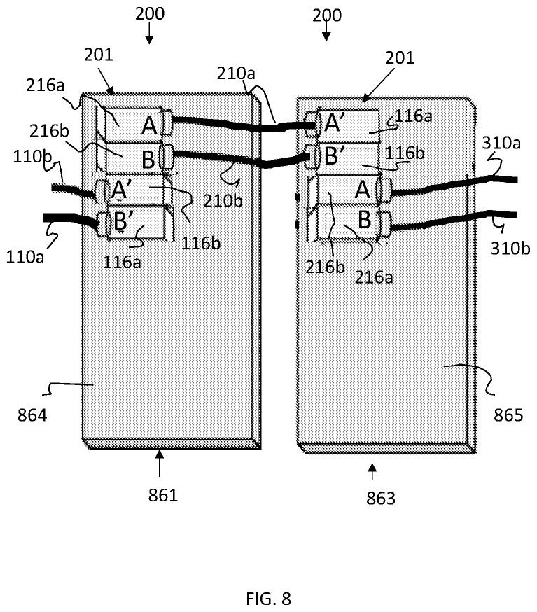

FIG. 8 is a top view of two PCBs, 861, 863, each having mounted thereon a terminal 200 as shown in the example of FIGS. 3A and 3B and described above. In the example of FIG. 8, conductive contact 105a disposed within elongate housing portion 116a (best illustrated in FIG. 3B) is electrically isolated from conductive contact 105b disposed within elongate housing portion 116b (best illustrated in FIG. 3B). Conductive contact 205a disposed with elongate housing portion 216a, is electrically isolated from conductive contact 205b disposed within elongate housing portion 216b. Accordingly, wire 210a is electrically isolated from wire 210b. Wire 110a is electrically isolated from wire 110b, and wire 310a is electrically isolated from wire 310b.

As can be seen in FIG. 8, connector 200 allows wires 110a and 110b to attach to PCB 861 at one side of housing 201, while wires 210a and 201b exit housing 201 at an opposite side of housing 201. Thus, wires 210a and 210b can extend directly from connector 201 on PCB 861 to connector 201 on PCB 863. Housing 201 of connector 200 on PCB 863 is defined by first and second elongate housing portions 116a and 116b, each of which defines a corresponding opening that faces openings provided by first and second elongate housing portions 216a and 216b on PCB 861. Connector 200 is advantageously constructed to avoid the need to route wires 210a and 210b around housing 201 in order to connect wires 210a and 210b to the corresponding openings in connector 200 on PCB 863. At the same time housing 201 of connector 200 can have a width dimension that can be almost as small as the length dimension of a single conductive contact (best illustrated in FIG. 3B). The length dimension of housing 201 is about equal to the width dimension of one conductive contact, multiplied by a total number of elongate housing portions comprising housing 201.

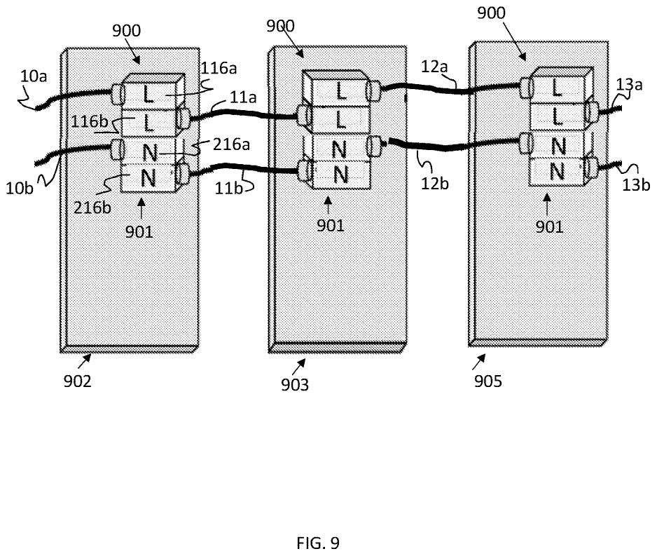

FIG. 9 shows 3 PCBs 902, 903 and 905. Each PCB has an electrical connector 900 mounted thereon. Electrical connectors 900 are similar to electrical connector 200 illustrated in FIGS. 3A and 3B, with the exception that elongate housing portions 116a and 116b of housing 201, are shown in FIG. 3A to define respective, corresponding openings 104a and 104b on a same side 107 of housing 201. In that embodiment corresponding conducting contacts 105a, 105b are arranged to connect to wires 110a, 100b extending through corresponding openings 104a, 104b. Likewise, elongate housing portions 216a, 216b are shown in FIG. 3A to define respective, corresponding openings 204a and 204b on opposing side 109 of housing 201. Corresponding conducting contacts 205a, 205b (best illustrated in FIG. 3B) are arranged to connect to wires 210a, 210b extending through corresponding openings 204a, 204b.

In contrast, each electrical connector 900 shown in FIG. 9 has a housing 901 in which first elongate housing portion 116a defines a corresponding opening at one end of housing 901 and second elongate housing portion 116b defines a corresponding opening at an opposite end of housing 901, and corresponding conducting contacts disposed within first and second elongate housing portions 116a, 116b are arranged accordingly. In the electrical conductors 900 illustrated in FIG. 9, wire 10a enters an opening defined by elongate housing portion 116a on one side of housing 901 and wire 11a exits housing 901 via an opening defined by elongate housing portion 116b on the opposite side of housing 901. Wire 10b enters housing 901 via an opening defined by elongate housing portion 216a on the same side of housing 901 as wire 10a enters housing 901. Wire 11b exits housing 901 on a side of housing 901 opposite the side of entry of wire 10b, and on the same side wire 11a exits housing 901.

Conducting contacts (not shown in FIG. 9) disposed within elongate housing portions 116a, 116b are electrically connected to each other such that wire 10a is electrically connected to wire 11a. However, the conducting contact disposed within elongate housing portion 116b is electrically insulated from the conducting contact disposed within elongate housing portion 216a so that wire 10b is electrically isolated from wires 10a and 11a.

The conducting contact disposed within elongate housing portion 216a is electrically connected to the conducting contact disposed within elongate housing portion 216b so that wire 10b is electrically connected to wire 11b. The conducting contact disposed within elongate housing portion 216b electrically insulated from the conducting contacts disposed within elongate housing portions 116a and 116b so that wires 10b and 11b are electrically insulated from wires 10a and 11a, and so forth.

Having described the embodiments in detail, those skilled in the art will appreciate that, given the present description, modifications may be made to the embodiments described herein without departing from the spirit of the inventive concept. Therefore, it is not intended that the scope of the invention be limited to the specific embodiments illustrated and described.

1. An electrical connector comprising:
a housing comprising at least a first elongate housing portion and a second elongate housing portion immediately adjacent the first elongate housing portion, each of the at least the first elongate housing portion and the second elongate housing portion extending longitudinally from a first end of the housing to an opposing second end of the housing,
the first elongate housing portion comprising a first opening at the first end of the housing and a first wall portion at the second end of the housing, and
the second elongate housing portion comprising a second opening at the second end of the housing and a second wall portion at the first end of the housing.

2. The electrical connector of claim 1, further comprising:
a first conductive contact within the first elongate housing portion and configured to electrically couple to a first wire received through the opening in the first end of the housing, and
a second conductive contact disposed within the second elongate housing portion and arranged to electrically couple to a second wire received through the opening in the second end of the housing.

3. The electrical connector of claim 2, wherein the first conductive contact is electrically coupled to the second conductive contact such that when the first conductive contact is coupled to the first wire and the second conductive contact is coupled to the second wire, the first wire is electrically coupled to the second wire.

4. The electrical connector of claim 3, further comprising a first conductive portion within the housing and extending between the first conductive contact and the second conductive contact to electrically couple the first conductive contact to the second conductive contact.

5. The electrical connector of claim 3, further comprising a second conductive portion on a surface of a printed circuit board, the second conductive portion electrically coupling the first conductive contact to the second conductive contact.

6. The electrical connector of claim 2, wherein the first conductive contact is electrically isolated from the second conductive contact such that when the first conductive contact is coupled to the first wire and the second conductive contact is coupled to the second wire, the first wire is electrically isolated from the second wire.

7. The electrical connector of claim 1, wherein the housing further comprises two or more pairs of elongate housing portions in which each pair provides a first opening at one end of the housing and a second opening at an opposing end of the housing.

8. The electrical connector of claim 1, wherein the housing further comprises two or more pairs of elongate housing portions, a first pair of which provides first and second openings at a first end of the housing, and a second pair of which provides first and second openings at an end of the housing opposite the first end.

9. The electrical connector of claim 2, wherein the housing further comprises a substantially rectangular bottom surface having a width dimension that is substantially the same as the length of one conductive contact.

10. The electrical connector of claim 1 wherein the first opening at the first end of the housing is configured to receive a first wire, and the first wall portion at the second end of the housing is configured to prevent the first wire from extending through the second end of the housing; and the second opening at the second end of the housing is configured to receive a second wire and the second wall portion at the first end of the housing is configured to prevent the second wire from extending through the first end of the housing.

11. A printed circuit board assembly comprising:
a printed circuit board defined by a first surface;
an electrical connector mounted on the first surface of the printed circuit board, the electrical connector comprising:
a housing comprising at least a first elongate housing portion and a second elongate housing portion immediately adjacent the first elongate housing portion, each of the first and second elongate housing portions extending longitudinally from a first end of the housing to an opposing second end of the housing,
the first elongate housing portion comprising an opening at the first end of the housing and a wall portion at the second end of the housing;
the second elongate housing portion comprising an opening at the second end of the housing and a wall portion at the first end of the housing.

12. The printed circuit board assembly of claim 11 wherein the electrical connector further includes:
a first conductive contact disposed within the first elongate housing portion and configured to electrically couple to a first wire received through the opening in the first end of the housing, and
a second conductive contact disposed within the second elongate housing portion and arranged to electrically couple to a second wire received through the opening in the second end of the housing.

13. The printed circuit board assembly of claim 12 wherein the first conductive contact is electrically coupled to the second conductive contact so that when the first conductive contact is coupled to the first wire and the second conductive contact is coupled to the second wire, the first wire is electrically coupled to the second wire.

14. The printed circuit board assembly of claim 12 wherein the first conductive contact is electrically coupled to the second conductive contact by a conductive portion extending therebetween, the conductive portion disposed within the housing.

15. The printed circuit board assembly of claim 12 wherein the first conductive contact is electrically coupled to the second conductive contact by a conductive portion disposed on a surface of the printed circuit board.

16. The printed circuit board assembly of claim 12 wherein the first conductive contact is electrically isolated from the second conductive contact so that when the first conductive contact is coupled to the first wire and the second conductive contact is coupled to the second wire, the first wire is electrically isolated from the second wire.

17. The printed circuit board assembly of claim 12 wherein each conductive contact is arranged with the corresponding elongate housing portion to extend longitudinally along a central longitudinal axis of the corresponding elongate housing portion, and the length of the of the corresponding elongate housing portion is generally coextensive with a length of the conductive contact so that the housing has a rectangular dimension that generally corresponds to the length of a single conductive contact.

18. The printed circuit board assembly of claim 12 further comprising an array of Light Emitting Diodes (LEDs) mounted on the first surface.

19. The printed circuit board assembly of claim 11, wherein the first opening at the first end of the housing is configured to receive a first wire, and the first wall portion at the second end of the housing is configured to prevent the first wire from extending through the second end of the housing; and the second opening at the second end of the housing is configured to receive a second wire and the second wall portion at the first end of the housing is configured to prevent the second wire from extending through the first end of the housing.

20. The printed circuit board assembly of claim 12 wherein the housing includes a substantially rectangular bottom surface having a width dimension that is substantially the same as the length of one conductive contact.
